(19) United States
(12) Patent Application Publication
(10) Pub. No.: US 2022/0234548 A1
(43) Pub. Date: Jul. 28, 2022

(54) DEVICE FOR CLEANING A GLASS SURFACE OF AN OPTICAL SENSOR FOR A MOTOR VEHICLE

(71) Applicant: Valeo Systèmes d'Essuyage, Le-Mesnil-Saint-Denis (FR)

(72) Inventors: Gérald Caillot, Le-Mesnil-Saint-Denis (FR); Vincent Izabel, Le-Mesnil-Saint-Denis (FR)

(73) Assignee: Valeo Systèmes d'Essuyage, Le-Mesnil-Saint-Denis (FR)

(21) Appl. No.: 17/596,292

(22) PCT Filed: May 5, 2020
(86) PCT No.: PCT/EP2020/062477

§ 371 Date: Dec. 7, 2021

(30) Foreign Application Priority Data
Jun. 7, 2019 (FR) FR1906129

(51) Int. Cl. B60S 1/56; B60S 1/52; G02B 27/00

(52) U.S. Cl. CPC B60S 1/566; G02B 27/0006; B60S 1/528; B60S 1/524

(57) ABSTRACT

The present invention relates to a telescopic cleaning device (100) for cleaning a glass surface (300) of a motor vehicle, comprising at least one hollow body (110) and a movable piston (120) configured to slide in the hollow body (110) along a deployment direction (D) between an extended position and a folded position, the movable piston being configured to support a member for cleaning the glass surface, the device being characterised in that it comprises two cleaning members consisting of a member for projecting (140) a cleaning fluid (FN) conveyed through the hollow body (110) and a wiper blade (130), the two cleaning members being rigidly connected to the movable piston.

The present invention relates to the field of cleaning of sensors/transmitters of a motor vehicle, and more particularly the cleaning of glass surfaces of optical sensors of optical detection systems of such vehicles.

The most recent motor vehicles are equipped with a collection of driving assistance systems that assist the driver or replace the driver in certain maneuvers. These driving assistance systems are usually triggered by the detection of a signal, whether this signal is optical, electrical or any other type. In the case of systems triggered by an optical signal, the sensor positioned to register the signal must be perfectly clean, so as to avoid non-triggering or ill-timed triggering of the system.

It is known practice to clean sensors of this type using a cleaning product sprayed by a spray device. The cleaning product is able to dissolve the dirt on the sensor.

Nevertheless, the subsequent drying of the cleaning product leaves a fluid residue that may adversely alter the image and bring about ill-timed and dangerous triggering of the system with which the sensor is associated.

Cleaning devices in which, in addition to a cleaning fluid sprayed first of all onto the optical surface to clean this optical surface and expel dirt, there is also provision to spray onto the optical surface a drying fluid, for example air, are therefore known. Thus, just after a cycle of cleaning by spraying liquid, for a period determined in particular as a function of the size of the optical sensor, air is conveyed to the dispensing endpiece arranged at the end of the cleaning device, then sprayed via this endpiece onto the optical surface. However, such air drying is not entirely satisfactory since there may still be traces of the fluid or more stubborn dirt which cannot be cleaned by simply spraying cleaning fluid then air drying.

The present invention falls within this context and aims to remedy at least the drawback mentioned by proposing a telescopic cleaning device for cleaning a glass surface of a motor vehicle, comprising at least one hollow body and a movable piston configured to slide in the hollow body in a direction of deployment between a deployed position and a retracted position, said movable piston being configured to support a cleaning member for cleaning the glass surface. According to the invention, the cleaning device comprises two cleaning members consisting of a spraying member for spraying a cleaning fluid conveyed through the hollow body and a wiper blade, said two cleaning members being rigidly secured to the movable piston.

The cleaning device is noteworthy in that it combines two complementary cleaning means, one of which requires a supply of fluid, on a telescopic support for conveying the cleaning fluid. The use of a telescopic nozzle makes it possible to keep the spraying member out of the field of vision of the camera when no cleaning is necessary and the arrangement of the blade on the movable piston ensures that the deployment of the nozzle, or spraying member, drives the blade. As the movable piston is mechanically connected to the wiper blade, it is understood that a movement of the movable piston in the direction of deployment also causes a movement of the wiper blade, in this same direction of deployment.

Moreover, the fact that the two cleaning means are rigidly secured to the same movable support, consisting of the piston, makes it possible to keep a constant distance between the nozzle and the blade throughout the cleaning operation, and from one cleaning operation to the next. This results in reproducible wiping conditions, something which is particularly advantageous in the field of driving assistance, where the images acquired by the sensor may be used for decision-making for steering the vehicle.

According to one aspect of the present invention, a piston deployment movement corresponds to a movement during which the movable piston goes from its retracted position to its deployed position, while a movable piston retraction movement corresponds to a movement during which the movable piston goes from its deployed position to its retracted position. According to various embodiments of the present invention explained in detail below, the spraying member can be configured to allow cleaning fluid to be sprayed onto the glass surface to be cleaned during the movable piston deployment movements. Optionally, it is also possible to provide an additional spray of cleaning fluid, which is carried out during the wiper blade retraction movements.

According to one feature of the invention, the wiper blade extends mainly along a transverse axis perpendicular to the direction of deployment of the movable piston, the main transverse axis of extension of the blade and the direction of deployment of the movable piston being inscribed in a plane parallel to a main plane of extension of the glass surface to be cleaned.

According to one feature of the invention, the at least one spraying member is configured to spray cleaning fluid upstream of the wiper blade in a direction of deployment of this wiper blade. In other words, spraying of cleaning fluid by the spraying member is always followed by wiping of the cleaning fluid thus sprayed by the wiper blade. It is understood that spraying of cleaning fluid upstream of the wiper blade thus allows rapid and efficient wiping of the cleaning fluid thus sprayed.

According to one feature of the present invention, an intermediate component is arranged at the free end of the movable piston, said intermediate component being configured to form a support for the wiper blade and to form a support for at least part of the spraying member.

According to one feature of the present invention, at least one outlet port for the cleaning fluid is made in the movable piston and the intermediate component has a through hole arranged opposite the outlet port to allow the passage of cleaning fluid to the spraying member. The outlet port for the cleaning fluid is made at a free end of the movable piston, that is to say at an end which extends outside the hollow body for conveying the cleaning fluid in which the movable piston slides.

For example, the wiper blade may comprise at least one structural element carrying a wiper rubber, at least part of which is intended to come into contact with the glass surface to be cleaned in order to wipe the cleaning fluid sprayed onto this glass surface. In a known manner, the wiper rubber may comprise at least one heel carried by the structural element and at least one lip connected to the heel by a hinge, this lip forming the part of the wiper rubber that is intended to come into contact with the glass surface.

According to a first embodiment of the present invention, the spraying member is formed by at least one spray head mechanically connected to the movable piston. For example, the intermediate component for mechanically connecting the movable piston to the wiper blade may be adapted to mechanically connect the spray head to this movable piston. In other words, according to this example, the intermediate component is fastened to the movable piston and carries both the wiper blade and the spray head. For example, the spray head may be welded to the intermediate component. It is understood that this is only an example and that any other means of fastening the spray head to the intermediate component may be contemplated without departing from the scope of the present invention.

The intermediate component may in particular be configured such that the blade is caught between hooks formed on this intermediate component and such that the spray head is attached to an outer face of a wall forming the base of the intermediate component, said outer face being turned away from the blade and the wall forming the base being configured to allow passage of the cleaning fluid toward the spraying member.

According to one feature of this first embodiment, the spray head is rigidly secured to the intermediate component and at least one trough is formed in the spray head, this trough extending mainly along a vertical axis perpendicular to the direction of deployment of the movable piston, in the direction of the glass surface to be cleaned. The trough helps to form, with a face of the intermediate component, a circulation duct for the cleaning fluid.

According to this feature of the first embodiment, the trough may have a first end arranged substantially at the center of the spray head and a second end opening out on one side of the head to form the spray orifice through which the fluid is sprayed onto the glass, these two ends being opposite along the vertical axis of extension of the trough. The head is fastened at the end of the movable piston such that the outlet port made in the movable piston opens out opposite the first end. In the vicinity of the second end, the trough is delimited by two walls which extend away from one another so as to present a flared shape which helps disperse the jet of cleaning fluid so as to increase the surface area over which this fluid is sprayed onto the glass surface.

It is therefore understood from the foregoing that the cleaning fluid arrives at the outlet port made in the movable piston in a direction parallel to the direction of deployment of this movable piston and that it is then redirected toward the glass surface to be cleaned as soon as it leaves this movable piston, by virtue of the trough formed in the spray head, and if necessary by an inclined plane configured to angle the cleaning fluid toward the blade.

According to this first embodiment, the spray head is advantageously arranged at a center of the wiper blade, relative to its transverse direction of elongation, such that spraying is as homogeneous as possible over the entire glass surface to be cleaned.

According to a second embodiment of the present invention, the spraying member is formed by at least one spray bar integrated into the wiper blade, this spray bar extending parallel to the main transverse axis of extension of the wiper blade. According to one feature of this second embodiment, the spray bar is offset, in the direction of deployment of the movable piston, relative to the wiper rubber of the wiper blade. In particular, the spray bar may be offset by being arranged in front of the wiper rubber with respect to this direction of deployment, that is to say by being further away from the hollow body than the wiper blade. Advantageously, it is understood that such a position of the spray bar makes it possible to spray the cleaning fluid during the deployment of the telescopic device before the wiper blade wipes the glass.

According to this second embodiment of the present invention, the spray bar is connected to a chamber for receiving the cleaning fluid which is rigidly secured to the intermediate component and arranged opposite the through hole made in this intermediate component.

The spray bar may comprise at least one cleaning fluid circulation channel, formed in the wiper blade, and at least one duct which places the cleaning fluid circulation channel in communication with an environment external to the cleaning device, and the outlet port for the cleaning fluid made in the movable piston is fluidly connected to the at least one cleaning fluid circulation channel.

For example, a tube may be arranged between the outlet port made in the movable piston and an end cap of the wiper blade, this end cap being in fluid communication with the cleaning fluid circulation channel formed in the wiper blade. Advantageously, the cleaning fluid circulation channel extends over an entire transverse dimension of the wiper blade, that is to say a dimension measured between two opposite ends of the wiper blade along the main transverse axis of extension of the wiper blade and parallel to this main transverse axis of extension. In other words, it is understood, according to this second embodiment, that the cleaning fluid is conveyed to the outlet port of the movable piston, then reaches the circulation channel formed in the wiper blade, for example via the tube arranged between this outlet port and the circulation channel, before being sprayed onto the glass surface to be cleaned via the at least one duct formed between this cleaning fluid circulation channel and the external environment.

According to one feature of the second embodiment, the spray bar comprises a plurality of ducts distributed along the cleaning fluid circulation channel. Advantageously, the use of several ducts distributed along the wiper blade makes it possible to ensure a homogeneous distribution of the cleaning fluid sprayed onto the glass surface to be cleaned and thus to ensure thorough cleaning of the whole of this glass surface.

According to a variant of this second embodiment, the spraying member may be formed by two spray bars which both extend parallel to the main transverse axis of extension of the wiper blade and which are thus distributed on either side of the wiper rubber of this wiper blade. According to this variant of the second embodiment, the first spray bar and the second spray bar comprise a common portion formed by the cleaning fluid circulation channel made in the wiper blade and differ from one another especially by the orientation of their respective ducts formed between the circulation channel and the external environment as mentioned above. Advantageously, these spray bars may be activated simultaneously, or else sequentially, that is to say one after the other. “Activate a spray bar” means implementing this spray bar so that it sprays the cleaning fluid onto the glass surface to be cleaned.

The present invention also relates to a motor vehicle comprising at least one optical detection system comprising at least one optical sensor equipped with at least one glass surface, the vehicle comprising at least one cleaning device according to the invention, this at least one cleaning device being configured to clean the glass surface of the optical sensor of the optical detection system.

According to an example of application of the present invention, the glass surface of the optical sensor of the optical detection system may be curved, a generatrix of this curved glass surface thus coinciding with the direction of deployment of the movable piston.

The present invention further relates to a method for implementing the cleaning device according to the invention, comprising at least one step during which a control unit receives information relating to a soiled state of a glass surface of an optical sensor of an optical detection system, at least one step during which the control unit determines a need for cleaning the glass surface as a function of the information received, at least one step during which the control unit sends an instruction to deploy a movable piston of the cleaning device and during which the control unit sends an instruction for spraying of the cleaning fluid by the spraying member, in which this fluid spray instruction may coincide with the instruction to deploy the movable piston in cases where this deployment is effected hydraulically with the cleaning fluid serving as hydraulic actuator. This method results in a step during which the wiper blade, carried by the movable piston, wipes the cleaning fluid sprayed onto the glass surface.

According to the variant of the second embodiment mentioned above, when the wiper blade comprises two spray bars, it is possible for the fluid to be sprayed by one of the spray bars then by the other, such that the cleaning fluid is always sprayed upstream of the wiper rubber.

In other words, cleaning fluid may be sprayed by a first spray bar when the movable piston is in the deployment phase, then by a second spray bar when the movable piston is in the retraction phase, such that the fluid sprayed is immediately wiped off by the wiper rubber.

Further features, details and advantages of the invention will emerge more clearly on reading the following description, on the one hand, and several embodiments provided by way of non-limiting example with reference to the attached drawings, on the other hand. In the drawings:

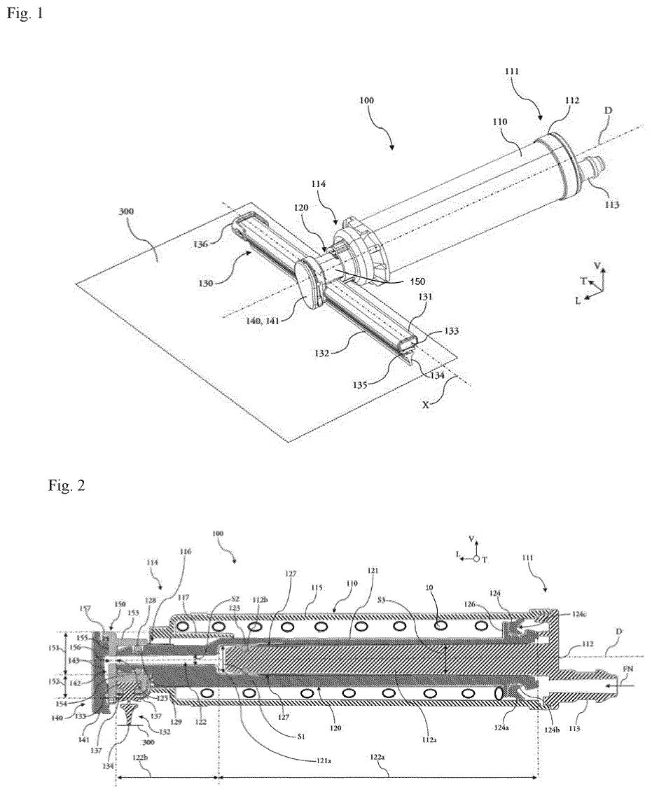

FIG. 1 shows, in perspective, a telescopic cleaning device according to a first embodiment of the present invention;

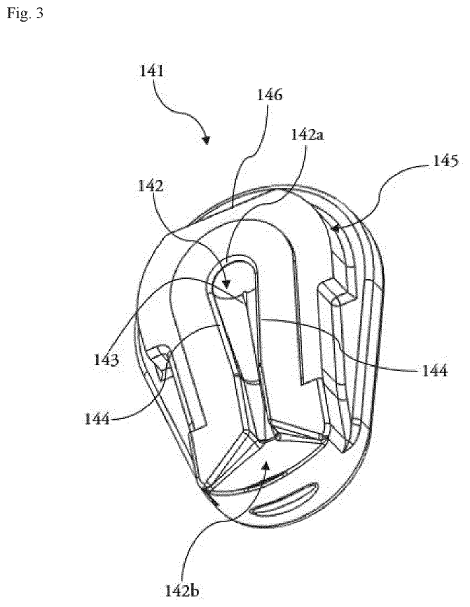

FIG. 2 shows a sectional view of the telescopic cleaning device according to the first embodiment of the present invention, the section being taken in a longitudinal and vertical plane;

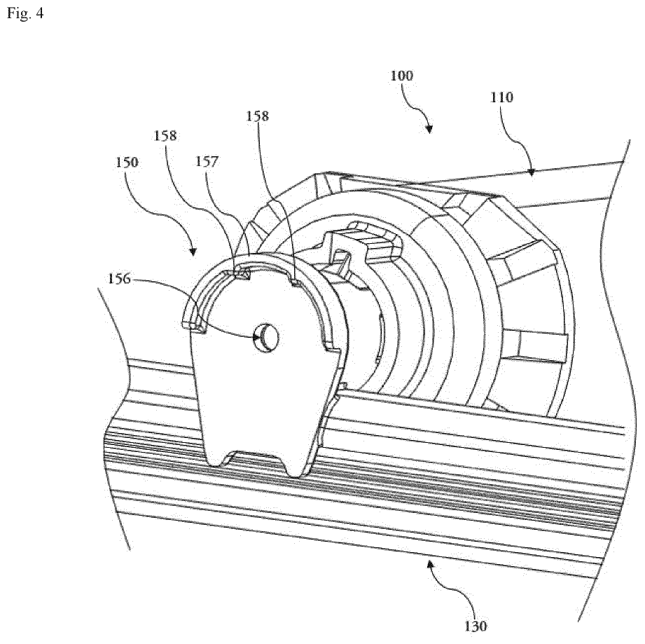

FIG. 3 shows, in perspective, a spray head of the telescopic cleaning device according to the first embodiment of the present invention;

FIG. 4 shows a perspective view of the telescopic cleaning device according to the first embodiment of the present invention, in which the spray head of FIG. 3 has been removed;

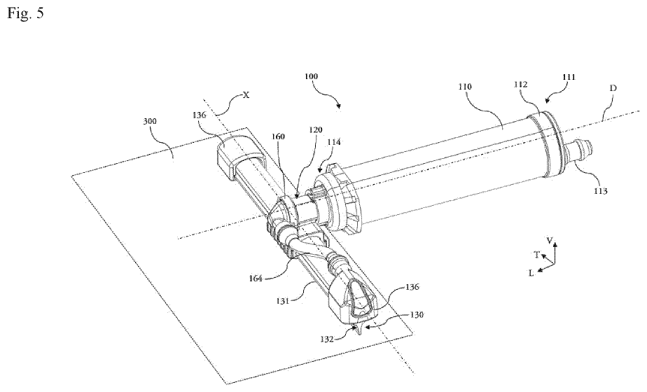

FIG. 5 shows, in perspective, a telescopic cleaning device according to a second embodiment of the present invention;

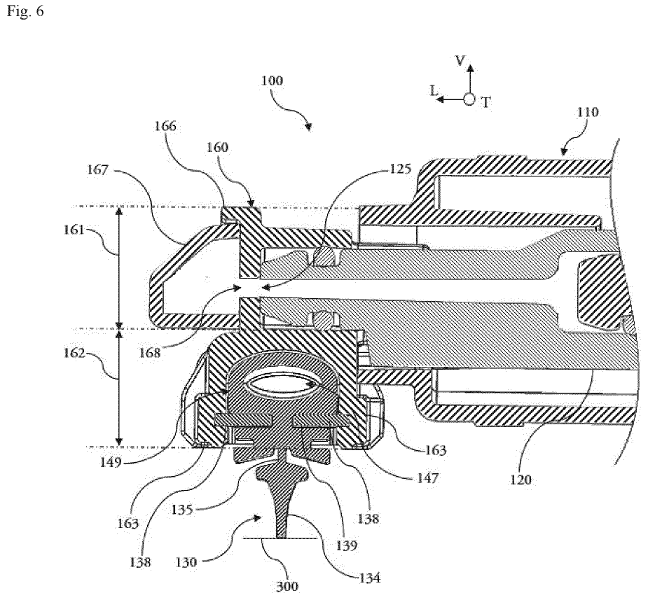

FIG. 6 shows, in section, a longitudinal end of the telescopic cleaning device according to the second embodiment of the present invention, this section being taken in a longitudinal and vertical plane;

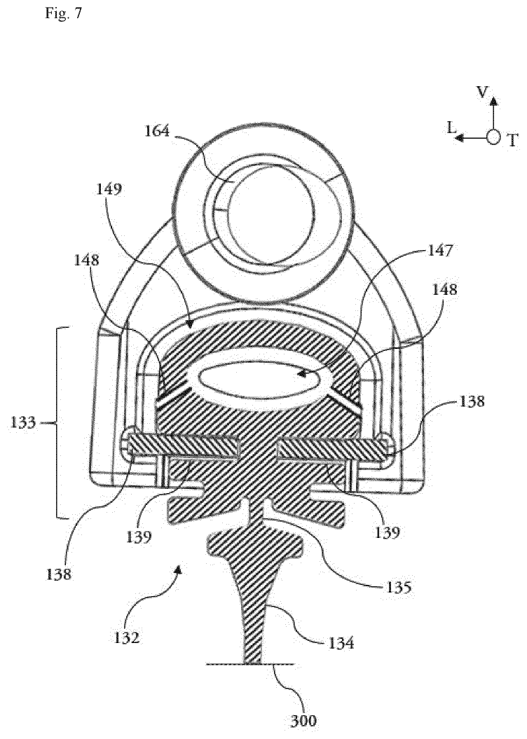

FIG. 7 shows, in section, a wiper blade of the telescopic cleaning device according to the second embodiment of the present invention, the section being taken in a longitudinal and vertical plane different to the sectional plane of FIG. 6;

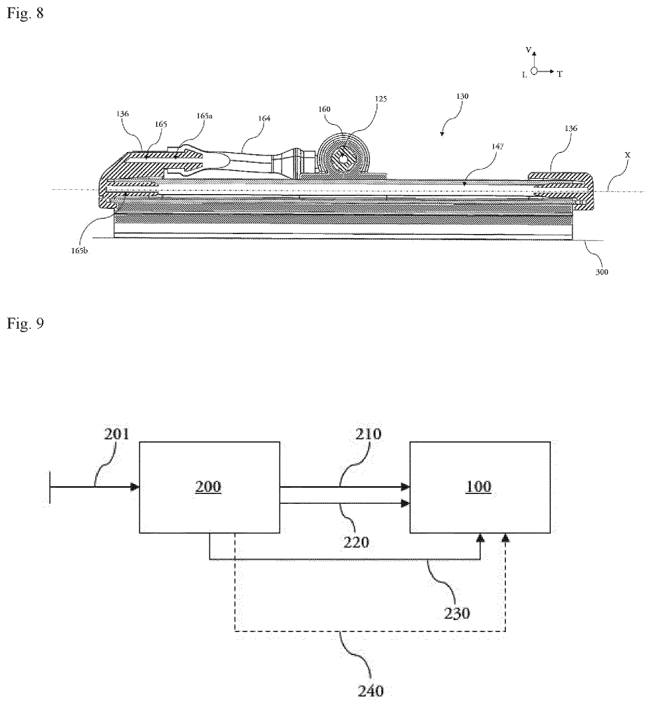

FIG. 8 shows, in section, the wiper blade of the telescopic cleaning device according to the second embodiment, the section being taken in a transverse and vertical plane perpendicular to the sectional plane of FIG. 6;

FIG. 9 shows, in the form of a block diagram, a method for implementing the telescopic cleaning device according to the present invention.

In the following description, the terms “longitudinal”, “transverse” and “vertical” refer to the orientation of a telescopic cleaning device according to the invention. A longitudinal direction corresponds to a direction of deployment of a movable piston of the telescopic cleaning device, this longitudinal direction being parallel to a longitudinal axis L of a coordinate system L, V, T shown in the figures. A transverse direction corresponds to a direction parallel to a main transverse axis of extension of a wiper blade of the telescopic cleaning device, this transverse direction being parallel to a transverse axis T of the coordinate system L, V, T and this transverse axis T being perpendicular to the longitudinal axis L. Finally, a vertical direction corresponds to a direction parallel to a vertical axis V of the coordinate system L, V, T, this vertical axis V being perpendicular to the longitudinal axis L and to the transverse axis T of this coordinate system L, V, T. The terms “below” and “above” refer to the position of an object along the vertical axis, the term “below” designating the objects closest to a glass surface to be cleaned by the telescopic cleaning device according to the invention.

FIGS. 1 and 5 both show, in perspective, a telescopic cleaning device 100 according to a first embodiment and a second embodiment, respectively, of the present invention. In the remainder of the description, the terms “telescopic cleaning device” and “cleaning device” will be used indiscriminately. First, we will describe the features common to these two embodiments before describing the specific aspects of each one.

The cleaning device 100 according to the invention thus comprises at least one hollow body 110 for conveying a cleaning fluid, which extends mainly in a longitudinal direction. As explained in more detail below, the hollow body 110 houses at least one movable piston 120 which is movable in a longitudinal direction D of deployment, between a deployed position and a retracted position. In the remainder of the description, the terms “deployment of the movable piston” refer to a movement of this movable piston from its retracted position to its deployed position, while the terms “retraction of the movable piston” refer to a movement of this movable piston from its deployed position to its retracted position.

As shown, the hollow body 110 of the cleaning device 100 extends between a first longitudinal end 111 closed by a cover 112 in which an inlet 113 for cleaning fluid FN is made, and a second longitudinal end 114 through which the movable piston 120 extends at least partially. The cleaning fluid inlet 113 is for example connected to a supply network of the motor vehicle in the form of a hydraulic bus or to a conventional cleaning fluid distribution network.

The cleaning device 100 according to the invention also comprises at least one wiper blade 130 which extends mainly along a transverse axis X and which is arranged at a free end of the movable piston 120. This wiper blade 130 comprises at least one structural element 131 carrying at least one wiper rubber 132 intended to come into contact with a glass surface 300 to be cleaned. As can be seen in particular in FIG. 1, the wiper rubber 132 comprises at least one heel 133 via which it is carried by the structural element 131 and from which extends a lip 134 which forms the portion of this wiper rubber intended to come into contact with the glass surface 300 to be cleaned. Note also that the lip 134 is connected to the heel 133 by a hinge 135 which ensures in particular that the lip 134 is flexible and thus that the glass surface 300 is wiped in two opposite directions. The wiper blade 130 is advantageously mechanically connected to the movable piston 120 such that deployment of this movable piston 120 allows wiping of the glass surface 300 to be cleaned in a first direction and that retraction of this movable piston in turn allows wiping of the glass surface to be cleaned in a second direction opposite to the first direction. Thus, the glass surface 300 is wiped twice, thereby improving the efficiency of the cleaning performed by the telescopic cleaning device 100 according to the invention.

According to the invention, the movable piston also forms a support for a cleaning fluid spraying member 140, such that the telescopic device according to the invention incorporates both a system of cleaning by wiping and a system of cleaning by fluid spraying, which move as one.

With reference to FIG. 2 in particular, we will now explain in detail the operating principle of the telescopic cleaning device 100, that is to say the means implemented for the deployment and retraction of the movable piston 120 of this cleaning device 100. This FIG. 2 shows the cleaning device 100 according to the first embodiment, but the functional description which follows is directly transposable to a cleaning device 100 produced according to the second embodiment.

This FIG. 2 more particularly depicts the cleaning device 100 according to the invention in section, this section being taken in a longitudinal and vertical plane, that is to say a plane in which both the longitudinal axis L of the coordinate system L, V, T and the vertical axis V of this coordinate system L, V, T are inscribed.

As mentioned above, the cleaning device 100 comprises a hollow body 110 for conveying the cleaning fluid, in which the movable piston 120 is housed, this piston being movable in the direction D of deployment. In the figures, the movable piston 120 is shown in its retracted position. As shown, the movable piston 120 comprises a peripheral wall 121 which delimits a hollow space 122. As will be explained in more detail below, this hollow space 122 is intended to be filled with cleaning fluid. Note also that the cover 112 which closes the first longitudinal end 111 of the hollow body 110 comprises a shaft 112a which extends into the hollow space 122 of the movable piston 120, in particular so as to serve as a means for guiding the sliding of the movable piston 120. Moreover, a first sealing device 123 is arranged between the shaft 112a of the cover 112 and the peripheral wall 121 of the movable piston which delimits the hollow space 122. More particularly, the shaft 112a of the cover 112 comprises an annular recess 112b in which this first sealing device 123 is received. According to an example shown here, this first sealing device 123 takes the form of an O-ring.

Furthermore, the hollow space 122 made in the movable piston 120 comprises at least two portions of different sections. Thus, the hollow space 122 may be divided virtually into a first portion 122a having a first section S1 and a second portion 122b having a second section S2 smaller than the first section S1 of the first portion 122a. As shown, the shaft 112a of the cover 112 is housed in the first portion 122a, that is to say the portion of the hollow space 122 having the largest section, and this shaft 112a has, at least partially, a third section S3 identical or substantially identical to the first section S1 of the first portion 122a of the hollow space 122. In other words, it is understood that the shaft 112a of the cover 112 is at least partially in contact with the peripheral wall 121 which delimits the hollow space 122, and more particularly with a portion of this peripheral wall 121 which delimits the first portion 122a of this hollow space 122.

The transition from one portion of the hollow space 122 to the other is sudden and the change in section is achieved by virtue of a shoulder 121a of the peripheral wall 121 which delimits this hollow space 122. Thus, the first portion 122a of the hollow space 122 is delimited, longitudinally, on the one hand by the cover 112 and on the other hand by the shoulder 121a of the peripheral wall 121 of the movable piston 120, and the second portion 122b of this hollow space 122 is in turn delimited longitudinally, on the one hand by the shoulder 121a of the peripheral wall 121 and on the other hand by an outlet port 125 configured to allow the ejection of the cleaning fluid. This outlet port 125 is thus formed at a free end of the movable piston 120, that is to say at an end of this movable piston 120 which extends beyond the hollow body 110. To be specific, as previously mentioned, the movable piston 120 extends, at least partially, beyond the hollow body 110. As shown, an opening 116 is made in the second longitudinal end 114 of the hollow body 110 so as to allow the passage of the movable piston 120. More particularly, at least part of the second portion 122b of the hollow space 122 of the movable piston 210 extends through this opening 116, when the movable piston 120 is in its retracted position. When the movable piston 120 is in its deployed position, the entire second portion 122b of the hollow space 120 extends beyond the second longitudinal end 114 of the hollow body 110, along with at least part of the first portion 122a of this hollow space 122.

This annular protuberance 126 is more particularly carried by the peripheral wall 121 of the movable piston 120 and it extends over an entire periphery of this peripheral wall 121. Advantageously, the annular protuberance 126 and the peripheral wall 121 of the movable piston 120 form a one-piece assembly, that is to say an assembly which cannot be separated without causing damage to the peripheral wall 121 or to the annular protuberance 126. As shown, a sealing ring 124 rests against this annular protuberance 126, this ring 124 also being in contact with a wall 115 of the hollow body 110. More particularly, this ring 124 comprises at least one outer lip 124a arranged in contact with the wall 115 of the hollow body 110 and an inner lip 124b arranged in contact with the peripheral wall 121 of the movable piston 120, the lips being arranged such that a furrow 124c is formed between them, this furrow 124c being intended to receive the cleaning fluid. In other words, the inlet 113 for cleaning fluid opens out on this ring 124, and more particularly on the furrow 124c in this ring 124.

Lastly, at least one groove 127—partially visible in FIG. 2—is made in the peripheral wall 121 of the movable piston 120, and more particularly in a portion of the peripheral wall 121 which helps delimit the first portion 122a of the hollow space 122. More precisely, this at least one groove 127 extends from the end of the movable piston 120, opening out at this free end, over a longitudinal dimension smaller than the longitudinal dimension between the cover and the annular recess 112b in which the first sealing device 123 is received.

In this way, in the retracted position as shown in FIG. 2, the grooves 127 extend longitudinally between the cover and the first sealing device 123, such that these grooves 127 are always formed upstream of the first sealing device 123 with respect to a direction of circulation of the cleaning fluid in the retracted position. Thus, at least in the retracted position, and in all the intermediate positions in which the grooves are always upstream of the first sealing device 123, this sealing device 123 makes it possible to prevent the cleaning fluid FN from reaching the second portion 122b of the hollow space 122, and therefore the outlet port 125, at an inopportune moment.

Advantageously, a plurality of grooves 127 are formed in the peripheral wall 121 of the movable piston 120, and more particularly in an internal face of this peripheral wall 121, that is to say a face turned toward the hollow space 122 and in at least partial contact with the shaft 112a of the cover 112. As will be explained in more detail below, these grooves 127 thus form channels for the circulation of the cleaning fluid FN and they are configured to allow this cleaning fluid to reach the second portion 122b of the hollow space 122 and thus the outlet port 125.

The hollow body 110 in turn has a cylindrical wall 115 open at its two longitudinal ends 111, 114 as previously mentioned. Thus, the first longitudinal end 111 is closed by the cover 112 and the second longitudinal end 114 is in turn closed by the movable piston 120 which extends partially through the opening 116. The wall 115 of the hollow body 110 has a tab 117 which extends from the second longitudinal end 114 of the hollow body 110, toward its first longitudinal end 111, said tab 117 being housed in the hollow body 110. As explained below, this tab 117 is intended to guide the deployment of the movable piston and to form a stop for the annular protuberance 126 carried by the peripheral wall 121 of the movable piston 120, so as to limit the deployment of the movable piston 120 and prevent it from coming out of the hollow body 110.

The tab 117 also makes it possible to define a housing for receiving a spring 10 shown schematically in FIG. 2, which extends between the second longitudinal end 114 and the annular protuberance 126 of the movable piston. The spring is configured so as to be in its rest position when the cleaning device is in the retracted position.

When cleaning is initiated by the cleaning device 100 according to the invention, the cleaning fluid FN reaches the hollow body 110 through the fluid inlet 113 made in the cover 112. The cleaning fluid then fills a chamber delimited by the sealing ring, the cover, the cylindrical wall of the hollow body and the shaft of the cover. Simultaneously, the cleaning fluid FN also propagates in the grooves 127 made in the peripheral wall 121 of the movable piston 120, the circulation of fluid being stopped at the end of the grooves 127.

The fluid filling the chamber comes in particular into the furrow 124c in the ring 124, generating pressure on the ring 124 and the associated movable piston. When this pressure is high enough to counteract the thrust force of the spring 10, the pressure of the fluid causes the movable piston 120 to move in the direction of deployment D. It is understood that during the deployment of the movable piston 120, there is a step during which the grooves 127 extend beyond the first sealing device 123 such that the cleaning fluid FN circulating therein can then reach the second portion 122b of the hollow space 122, then the outlet port 125, allowing it to leave the cleaning device 100. The spring 10, forming an elastic return device, allows the movable piston to retract once the glass surface 300 has been cleaned.

It is understood from the above that the deployment of the movable piston 120 is in this case controlled by the arrival of cleaning fluid FN in the hollow body 110 of the cleaning device. It is understood that this is only one embodiment and that the movable piston 120 could be deployed and retracted using an electric motor or any other compatible means, without departing from the context of the present invention.

As specified above, the device is particular in that the movable piston forms a support both for a wiper blade and for a member for spraying cleaning fluid. More particularly, the movable piston 120 is mechanically connected to the wiper blade 130 of the cleaning device 100 and in that the outlet port 125 is in turn in fluid communication with a spraying member 140 configured to spray the cleaning fluid upstream of the wiper blade 130 in a direction of movement of this wiper blade 130. The first and second embodiments according to the invention differ from one another, in particular in terms of the shape and arrangement of this spraying member 140.

With reference to FIGS. 1 to 4, we will now describe the first embodiment of the present invention.

As mentioned above, the wiper blade 130 is mechanically connected to the movable piston 120. According to the first embodiment shown here, this mechanical connection is made by means of an intermediate component 150 which also forms the structural element 131 of the wiper blade 130. The structural element 131 in this case takes the form of an anchoring zone which includes two hooks 137 configured to grip the heel 133 of the wiper rubber 132, thus leaving free the wiping lip 134 intended to come into the contact with the glass surface to be cleaned and the hinge which allows this wiping lip 134 to turn over in order to ensure optimum cleaning of the glass surface 300 in question. It can also be seen in FIG. 1 that the wiper blade 130 includes at least one end cap 136 for securely retaining this anchoring zone on the heel 133 of the wiper rubber 132. In other words, this at least one end cap 136 helps hold the structural element 131 and the wiper rubber 132 together. Optionally, the wiper blade 130 may include another end cap similar or identical to that which has just been described, arranged at an end of the wiper blade 130 opposite the end carrying the end cap just described.

As can be seen in FIG. 2, the intermediate component 150 has an upper part 151 and a lower part 152 arranged one above the other along the vertical axis V of the coordinate system L, V, T shown. As shown, the anchoring zone forming the structural element 131 of the wiper blade 130 is formed in the lower part 152 of this intermediate component 150, that is to say the part of this intermediate component that is closest to the glass surface 300 to be cleaned. This anchoring zone more particularly has at least two hooks 137 facing one another which sandwich the heel 133 of the wiper rubber 132. The upper part 151 of this intermediate component 150 in turn has the general shape of a U, that is to say that this upper part 151 of the intermediate component 150 comprises at least one first longitudinal arm 153, at least one second longitudinal arm 154 parallel to the first arm 153, and at least one base 155 which connects the first arm to the second arm and which extends perpendicularly, or substantially perpendicularly, to the first arm 153 and to the second arm 154. As shown, this U-shaped upper part 151 forms a zone for receiving the free end of the movable piston 120, that is to say the end of this movable piston 120 which extends beyond the hollow body 110 and in which the outlet port 125 is formed. In other words, it is understood that the first arm 153 and the second arm 154 of the upper part 151 of the intermediate component 150 extend from the base 155, toward the hollow body 110. Note also that the base 155 of the U-shape of the upper part 151 of the intermediate component 150 has a through hole 156 arranged opposite this outlet port 125.

Lastly, at least a second sealing device 128 is interposed between the free end of the movable piston 120 and the first and second arms 153, 154 which help delimit the zone for receiving this free end of the movable piston 120. More particularly, this second sealing device 128 is arranged in a recess 129 formed in an outer face of the peripheral wall 121 of the movable piston 120. For example, this second sealing device 128 may take the form of an O-ring.

The intermediate component 150 further comprises at least one rim 157 which extends from the base 155 of the U-shape forming the zone for receiving the movable piston 150, in the direction away from the hollow body 110.

The spraying member 140 of the cleaning device 100 according to the first embodiment is formed by a spray head 141. As partially visible in FIG. 2, this spray head 141 comprises a trough 142 arranged facing the through hole 156 made in the intermediate component 150. In other words, it is understood that this through hole 156 allows a fluid connection between the outlet port 125 formed in the movable piston 150 and the trough 142 formed in the spray head 141.

The trough 142 helps form, together with the face of the base 155 facing the spraying member, a cleaning fluid circulation channel. As shown, this trough 142 extends mainly parallel to the vertical axis V such that the cleaning fluid FN which arrives at the outlet port 125 in a direction parallel to the direction D of deployment is redirected, by an end wall 143 of this trough 142, substantially perpendicularly toward the glass surface 300 to be cleaned.

FIG. 3 shows more particularly, in perspective, the spray head 141. As shown, the trough 142 extends between a first end 142a arranged substantially in the center of the spray head and an open second end 142b which allows the cleaning fluid to be sprayed onto the glass surface to be cleaned. Between these ends, the trough 142 is delimited by its end wall 143 and by at least two side walls 144 which meet at the first end 142a. In other words, it is understood that it is the junction between these two side walls 144 which closes off this first end 142a. Conversely, at the second end 142b of the trough, these two side walls 144 extend away from one another. In other words, the second open end 142b has a flared shape, that is to say that this second end 142b has an increasingly large section in the direction away from the first end 142a. Advantageously, this makes it possible to enlarge the angle of spraying of the cleaning fluid, and thus to spray this cleaning fluid over a larger surface area of the glass surface, thereby improving the cleaning of this glass surface.

Furthermore, note that in the example shown, the second end of the trough opens onto an inclined plane arranged at the outlet of the trough so as to break up and deflect the jet of cleaning fluid leaving this trough. The inclination of this plane is configured such that the jet of cleaning fluid is angled appropriately, upstream of the blade 130.

The trough 142 is more particularly made in a stud 145 formed on a face of the spray head 141 turned toward the hollow body when this spray head 141 is in the working position. As shown, this stud 145 has an area less than an area of the face of the spray head 141 on which it is formed and this stud 145 has at least one flat segment 146 formed above the first end 142a of the trough 142. This flat segment 146 is adapted to interact with the rim 157 of the intermediate component 150, this rim 157 being for example shown in FIG. 4.

This FIG. 4 thus shows, in perspective, the cleaning device 100 according to the first embodiment, with the spray head 141 removed. Thus, FIG. 4 shows particularly clearly a face of the intermediate component 150 which receives the spray head, and the through hole 156 made in this intermediate component 150, opposite the outlet port of the movable piston. According to the invention, the spray head 141 may for example be welded to the intermediate component 150. It is understood that this is only one example which should not limit the present invention. Moreover, the intermediate component 150 comprises the rim 157 intended to interact with the spray head, and more particularly with the flat segment described above. Thus, the rim 157 comprises at least one lug 158, two lugs 158 in the example shown, which also help hold the spray head 141 in place, by interacting with the flat segment formed on the spray head.

With reference to FIGS. 5 to 8, we will now describe the second embodiment of the present invention.

FIG. 5 first of all shows, in perspective, the cleaning device 100 according to the second embodiment. Just as described above with reference to the first embodiment, the cleaning device 100 comprises the hollow conveying body 110 in which the movable piston 120 slides. The cleaning device 100 also includes the wiper blade 130 for wiping the glass surface 300 to be cleaned. As previously mentioned, this wiper blade 130 comprises at least one structural element 131, a wiper rubber 132 and at least one end cap 136, advantageously two end caps 136, configured to hold the structural element 131 and the wiper rubber 132 together. Moreover, this wiper blade 130 is mechanically connected to the movable piston by an intermediate component 160, shown more clearly in FIG. 6.

FIGS. 6 and 7 both show sections of the wiper blade 130 according to the second embodiment of the present invention, these sections being taken in two longitudinal and vertical planes, that is to say planes in which the longitudinal axis L and the vertical axis V of the coordinate system shown are inscribed, at a distance from one another. Thus, the section shown in FIG. 6 is taken in a plane passing through the intermediate component 160 while the section shown in FIG. 7 is taken in a plane passing between the intermediate component and one of the end caps of the wiper blade.

This second embodiment differs from the first embodiment in particular in that the spraying member 140 is formed by at least one spray bar integrated into the wiper blade 130. This spray bar comprises at least one cleaning fluid circulation channel 147 made in the wiper blade 130, and more particularly in an upper portion 149 of the heel 133 of the wiper rubber 132 of this wiper blade 130, and at least one duct 148—for example shown in FIG. 7—which places the circulation channel 147 in communication with an environment external to the cleaning device 100. More specifically, the spray bar includes a plurality of ducts 148 distributed along the wiper blade between the two end caps. In the example shown, the spraying member comprises two spray bars which include a common portion formed by the cleaning fluid circulation channel 147 and which each include a plurality of ducts 148 distributed along the wiper blade. As shown, the two spray bars, and more particularly the ducts 148 of each of these spray bars, are distributed on either side of the wiper rubber 132. According to the invention, these ducts 148 may be equipped with closure means—not shown here—which make it possible to spray cleaning fluid through only one of the spray bars at a time. Thus, the cleaning fluid can be systematically sprayed upstream of the wiper rubber, whether the piston is in the deployment or retraction phase, so that the cleaning fluid is wiped off immediately after it has been sprayed.

As shown in these FIGS. 6 and 7, the structural element of the wiper blade is formed by two vertebrae 138, each received in a housing 139 formed in the heel 133 of the wiper blade 132, and more particularly below the upper portion 149 of the heel 133 in which the cleaning fluid circulation channel 147 is formed.

As shown in FIG. 6, the intermediate component 160 comprises an upper part 161 identical to the upper part of the intermediate component according to the first embodiment and a lower part 162 which comprises two hooks 163 which extend toward one another and which each grip one of the vertebrae 138 forming the structural element of the wiper blade 130.

Furthermore, this intermediate component 160 also has a rim 166 which extends away from the hollow body 110 and which interacts with a chamber 167 for receiving the cleaning fluid. Note that this chamber 167 is arranged facing a through hole 168 made in the intermediate component and arranged facing the outlet port 125 of the movable piston 120. In other words, this through hole 168 makes it possible to establish a fluid connection between the outlet port 125 of the movable piston 120 and the chamber 167 for receiving the cleaning fluid. This chamber 167 may for example be welded to the intermediate component 160 and it is extended by a tube 164—partially visible in FIG. 7—which allows this chamber 167 in which the cleaning fluid is received to be placed in communication with the circulation channel 147 formed in the wiper blade 130. As can be seen in FIG. 5, the tube 164 extends as far as a cap 136 configured to redirect the cleaning fluid toward the circulation channel opening into said cap. It is understood that this is only one embodiment, and that the chamber could be secured to the intermediate component by any other known means without departing from the scope of the present invention.

As for FIG. 8, this shows, seen in section from the conveying body, the wiper blade 130. This section is taken in a transverse and vertical plane, that is to say a plane in which the transverse axis T and the vertical axis V of the coordinate system shown are inscribed. Thus, FIG. 8 shows particularly clearly the outlet port 125 of the movable piston as well as the circulation channel 147 formed in the wiper blade 130. As shown, the outlet port 125 is connected to the tube 164, itself connected to the end cap 136, itself in fluid communication with the cleaning fluid circulation channel 147 formed in the wiper blade 130. The cleaning fluid leaves the hollow body through the outlet port 125 made in the movable piston before reaching the tube 164, the end cap 136 and the circulation channel 147, in that order. Thus, as partially shown, a supply channel 165 is formed in the end cap 136 connected to the tube 164, this supply channel 165 comprising at least a first end 165a which extends into the tube 164 and at least a second end 165b which in turn extends into the circulation channel 147 formed in the wiper blade. Advantageously, such an arrangement makes it possible to limit, or even prevent, any leaks of cleaning fluid.

Lastly, FIG. 9 schematically shows, in the form of a block diagram, a method for implementing the cleaning device 100 according to the invention. As shown, a control unit 200 thus receives information 201 relating to a soiled state of the glass surface in question. Based on this information 201, the control unit 200 determines whether or not the glass surface should be cleaned. If this glass surface does require cleaning, the control unit 200 sends a first instruction 210 to deploy the movable piston of the cleaning device 100. As mentioned above, this first instruction 210 may correspond to an instruction to supply cleaning fluid to the hollow body, or an instruction to start an electric motor configured to allow the deployment of this movable piston. In the latter case, the control unit 200 also sends, advantageously simultaneously, a second instruction 220 to spray the cleaning fluid toward the glass surface to be cleaned. Deployment of the movable piston causes the wiper blade to wipe the glass surface, so that the cleaning fluid sprayed onto the glass surface is immediately dried by the wiper blade. Advantageously, this wiping can also make it possible to clean dirt that cannot be cleaned simply by spraying cleaning fluid. In the case of an electric motor for the deployment of the movable piston, and if there is no return spring in position housed in the hollow body 110, once the movable piston is in its deployed position, the control unit 200 can send a third instruction 230 to retract the movable piston. Advantageously, it is understood that retraction of this movable piston allows another wiping action by the wiper blade, which makes it possible to definitively ensure that the glass surface has in fact been cleaned.

In the implementation of the second embodiment of the present invention, with spray orifices on either side of the rubber, the second instruction 220 is more specifically an instruction to spray cleaning fluid sent to one of the two spray bars, in this case a first spray bar which comprises ducts arranged upstream of the wiper rubber in the direction of movement of the wiper blade. Provision can then be made for the control unit 200 to send a fourth instruction 240, simultaneously with the movable piston retraction sequence, for the spraying of cleaning fluid by a second spray bar, the ducts of which are then located upstream of the wiper rubber relative to the direction of movement of the wiper blade. In other words, according to this alternative, the spraying of the cleaning fluid is adapted according to the direction of movement of the wiper blade.

Advantageously, this allows a second cleaning of the glass surface, thus ensuring more efficient cleaning of this glass surface.

The present invention thus proposes a simple and inexpensive way to improve the cleaning of glass surfaces of optical sensors of driving assistance systems. The integration of functions in a telescopic nozzle, with a movable piston which is rigidly secured both to a wiper blade and to a spray head, makes it possible to ensure the back-and-forth movement of the wiper blade by the same operation of setting in motion as required for the deployment of the nozzle.

However, the present invention is not limited to the means and configurations described and illustrated herein and it also extends to all equivalent means and configurations and to any technically functional combination of such means. In particular, the shape and the arrangement of the spraying member and the wiper blade may be modified without detriment to the invention, provided that they provide the functionalities described in the present document.

1. A telescopic cleaning device for cleaning a glass surface of a motor vehicle, comprising:
at hollow body and a movable piston configured to slide in the hollow body in a direction of deployment between a deployed position and a retracted position,
said movable piston being configured to support a cleaning member for cleaning the glass surface; and
two cleaning members consisting of a spraying member for spraying a cleaning fluid conveyed through the hollow body and a wiper blade, said two cleaning members being rigidly secured to the movable piston.

2. The cleaning device as claimed in claim 1, wherein the wiper blade extends mainly along a transverse axis perpendicular to the direction of deployment of the movable piston, the main transverse axis of extension of the wiper blade and the direction of deployment of the movable piston being inscribed in a plane parallel to a main plane of extension of the glass surface to be cleaned.

3. The cleaning device as claimed in claim 1, wherein the at least one spraying member is configured to spray cleaning fluid upstream of the wiper blade in a direction of deployment of this wiper blade.

4. The cleaning device as claimed in claim 1, wherein an intermediate component is arranged at the free end of the movable piston, said intermediate component being configured to form a support for the wiper blade and to form a support for at least part of the spraying member.

5. The cleaning device as claimed in claim 4, wherein at least one outlet port for the cleaning fluid is made in the movable piston and the intermediate component has a through hole arranged opposite the outlet port to allow the passage of cleaning fluid to the spraying member.

6. The cleaning device as claimed in claim 4, wherein the spraying member is formed by at least one spray head mechanically connected to the movable piston.

7. The cleaning device as claimed in claim 6, wherein the spray head is rigidly secured to the intermediate component and wherein at least one trough is formed in the spray head, the trough extending mainly along a vertical axis perpendicular to the direction of deployment of the movable piston, in the direction of the glass surface to be cleaned, the trough helping to form, with a face of the intermediate component, a circulation duct for the cleaning fluid.

8. The cleaning device as claimed in claim 5, wherein the spraying member is formed by at least one spray bar integrated into the wiper blade, this spray bar extending parallel to the main transverse axis of extension of the wiper blade.

9. The cleaning device as claimed in claim 8, wherein the spray bar is connected to a chamber for receiving the cleaning fluid which is rigidly secured to the intermediate component and arranged opposite the through hole made in this intermediate component.

10. A motor vehicle comprising:
at least one optical detection system comprising at least one optical sensor equipped with at least one glass surface; and
at least one cleaning device as claimed in claim 1 being configured to clean the glass surface of the optical sensor of the optical detection system.
